(19) United States
(12) Patent Application Publication
(10) Pub. No.: US 2013/0134136 A1
(43) Pub. Date: May 30, 2013

(54) ELECTRICAL SOLDERING IRON HEAD

(71) Applicant: GUAN-NAN REN, Shenzhen City (CN)

(72) Inventor: GUAN-NAN REN, Shenzhen City (CN)

(73) Assignees: HON HAI PRECISION INDUSTRY CO., LTD., Tu-Cheng (TW); HONG FU JIN PRECISION INDUSTRY (Shenzhen) CO., LTD, Shenzhen City (CN)

(21) Appl. No.: 13/332,389

(22) Filed: Dec. 21, 2011

(30) Foreign Application Priority Data
Nov. 29, 2011 (CN) 201110386900.0

(51) Int. Cl. B23K 3/02

(52) U.S. Cl. 219/85.1

(57) ABSTRACT

An electric soldering iron head includes a heat-conducting pipe, a connecting member mounted to the heat-conducting pipe, a first heating block extending down from the connecting member, a second heating block slidably attached to the connecting member, and an operation member rotatably installed in the connecting member. The operation member includes a gear. The first heating block includes a first clamping portion. The second heating block includes a gear rack meshing with the gear and a second clamping portion facing the first clamping portion. When the operation member is operated to rotate, the gear drives the gear rack to slide, the second clamping portion slides toward or away from the first clamping portion.

### BACKGROUND

1. Technical Field

The present disclosure relates to an electrical soldering iron head.

2. Description of Related Art

An electronic component, such as a resistor or a capacitor, includes two pins to be soldered on two pads of a printed circuit board (PCB) with an electrical soldering iron. However, if the soldering of the two pins of the electronic component is not carried out in one operation, it would be inefficient and often time-consuming.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present embodiments. Moreover, in the drawing, all the views are schematic, and like reference numerals designate corresponding parts throughout the several views.

FIG. 1 is an exploded, isometric view of an exemplary embodiment of an electrical soldering iron head.

FIG. 2 is an inverted view of FIG. 1.

FIG. 3 is an assembled, isometric view of the electrical soldering iron of FIG. 1.

FIG. 4 is similar to FIG. 3, but shows a using state of the electrical soldering iron head.

FIG. 5 is a sectional view of FIG. 3, taken along the line of V-V.

FIG. 6 is a sectional view of FIG. 4, taken along the line of VI-VI.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

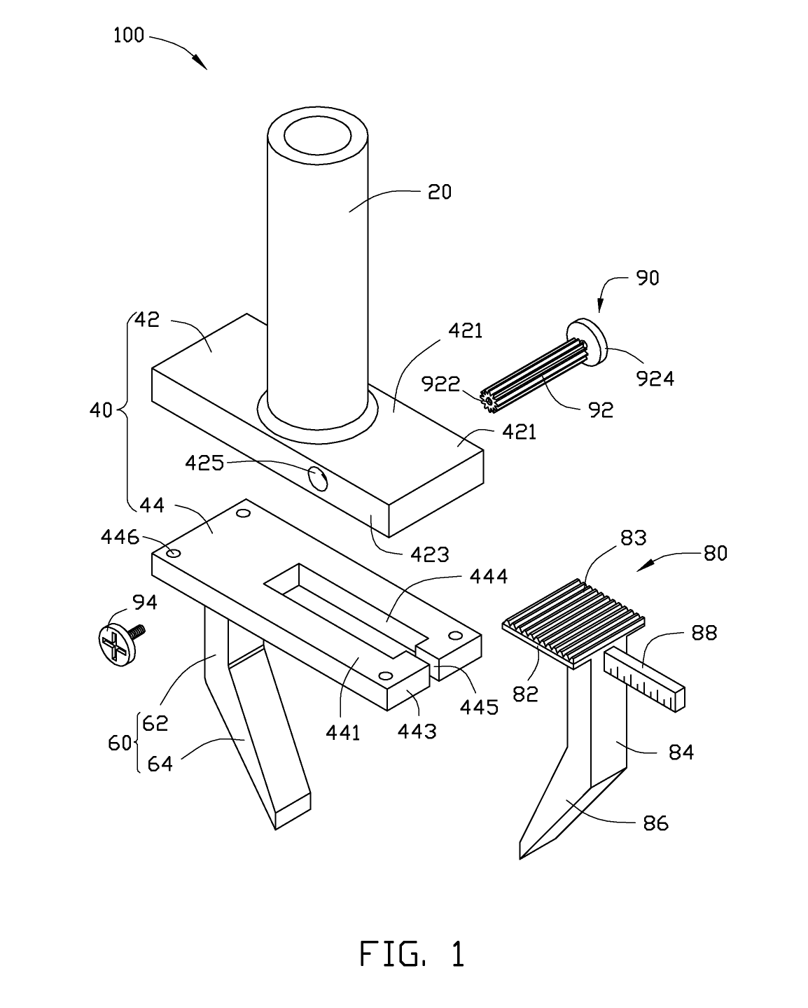

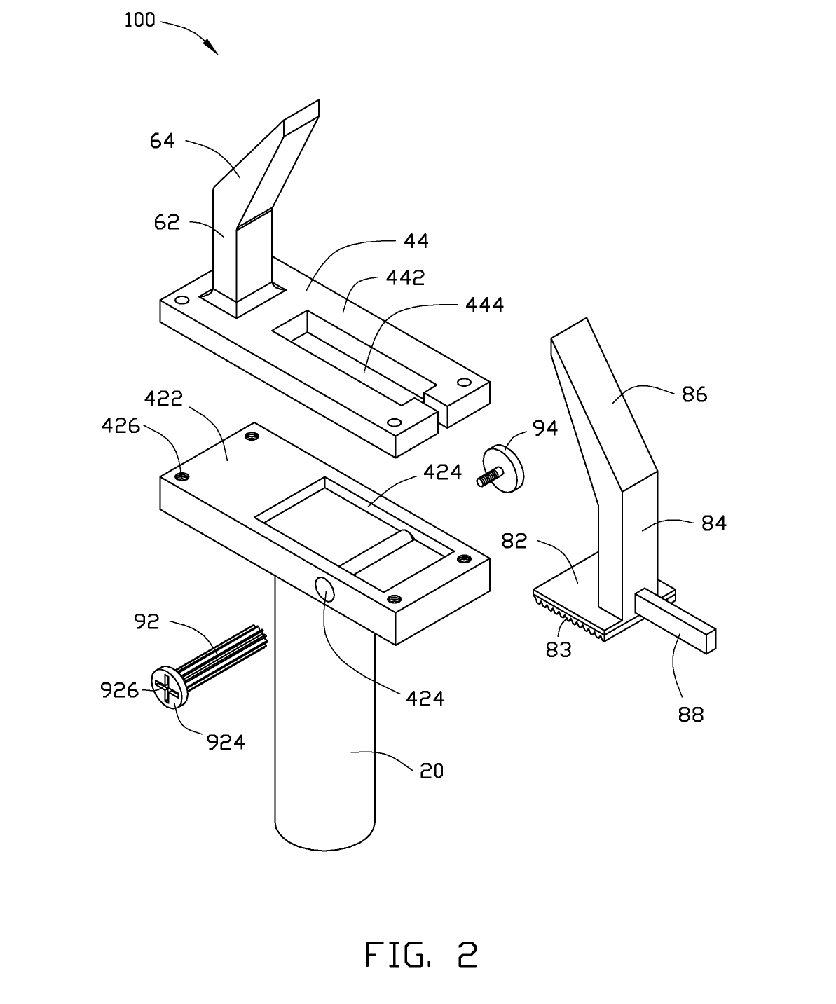

FIG. 1 and FIG. 2, show an embodiment of an electrical soldering iron head 100 including a heat-conducting pipe 20, a connecting member 40, a first heating block 60, a second heating block 80, and an operation member 90.

The heat-conducting pipe 20 can be connected to a heat pole of an ordinary electric soldering iron (not shown).

The connecting member 40 includes a rectangular fixing block 42 fixed to an end of the heat-conducting pipe 20, and an installation block 44.

The fixing block 42 includes a top surface 421 fixed to the heat-conducting pipe 20, a bottom surface 422 defining a rectangular receiving space 424, and two opposite side surfaces 423. The receiving space 424 extends along a lengthwise direction of the fixing block 42. The fixing block 42 defines a through hole 425 extending through the side surfaces 423, and four screw holes 426 in four corners of the bottom surface 422. The through hole 425 communicates with the receiving space 424.

The installation block 44 includes a top surface 441, a bottom surface 442 opposite to the top surface 441, and two opposite end surfaces 443. The installation block 44 defines a guiding slot 444 extending along a lengthwise direction of the installation block 44, a cutout 445 extending through one of the end surfaces 443 adjacent to the guiding slot 444, and four fastening holes 446 in four corners of the top surface 441. The guiding slot 444 communicates with the guiding slot 444.

The first heating block 60 includes a first extending pole 62 perpendicularly extending down from the installation block 44 opposite to the cutout 445, and a first clamping portion 64 slantingly extending from a distal end of the extending pole 62 toward the guiding slot 444.

The second heating block 80 includes a sliding piece 82, a gear rack 83 fixed on a top of the sliding piece 82. A second extending pole 84 perpendicularly extends down from a first end of the sliding piece 82 opposite to the gear rack 83, a second clamping portion 86 slantingly extending down from a distal end of the extending pole 84 toward a second end of the sliding piece 82. In addition, a pin 88 extends out from a lateral side of the extending pole 84 opposite to the second end of the sliding piece 82. The extending pin 88 is marked with a length scale.

The operation member 90 includes a gear 92 and a screw 94. A circular operation portion 924 extends out from a first end of the gear 92. A diameter of the operation portion 924 is greater than a diameter of the through hole 425. A second end of the gear 92 opposite to the operation portion 924 axially defines a screw hole 922.

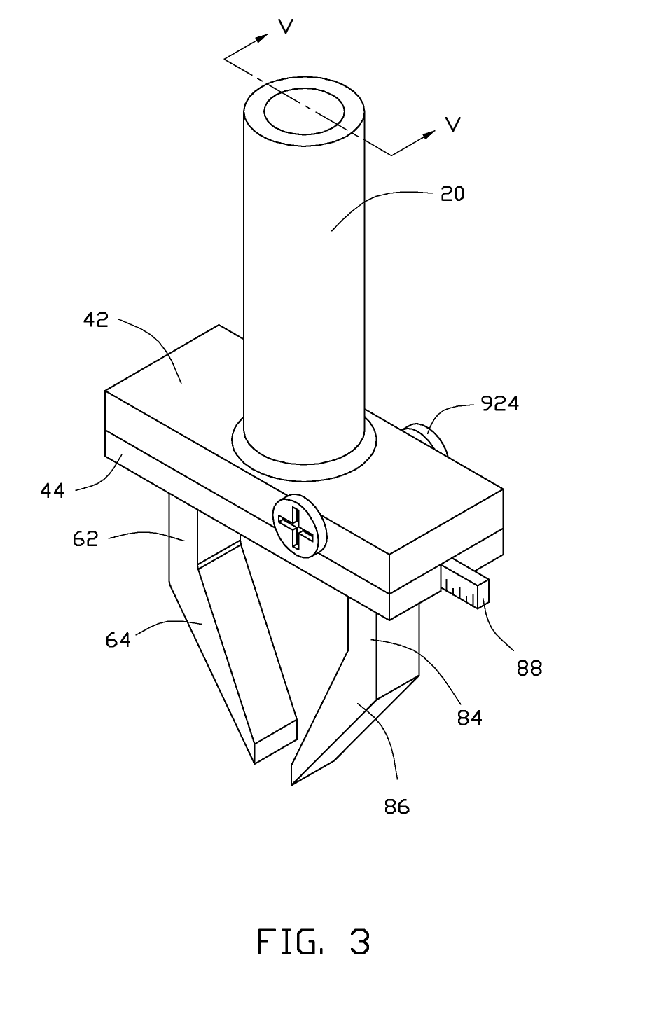

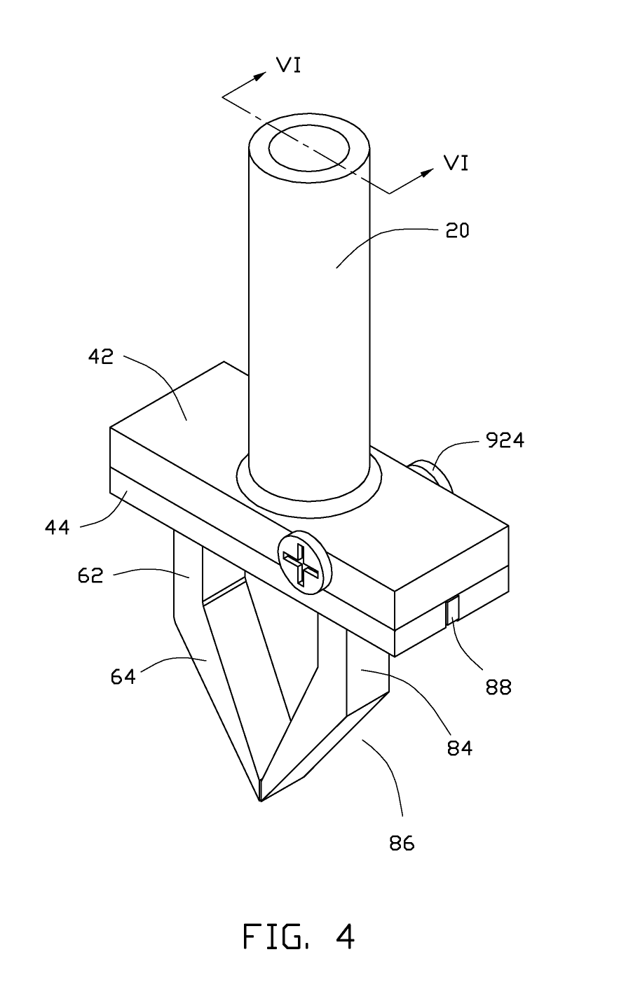

Referring to FIG. 3 and FIG. 4, in assembly, the gear 92 is rotatably inserted into the through hole 425. The second clamping portion 86 extends through the guiding slot 444 from the top surface 441, with the second extending pole 84 slidably received in the guiding slot 444. The sliding piece 82 is slidably blocked by the top surface 441. The pin 88 is slidably received in the cutout 445. The bottom surface 422 is supported on the top surface 441. The sliding piece 82 is slidably received in the receiving space 424. The gear rack 83 meshes with the gear 92. Four screws extend though the fastening holes 446, to be screwed into the corresponding screw holes 426. The screw 94 is inserted into the through hole 425 to screw into the screw hole 922, for preventing the gear 92 from being disengaged from the through hole 425. Therefore, the gear 92 is rotatably received in the through hole 425, the gear 92 is rotated to drive the gear rack 83 to slide. The second clamping portion 86 slides toward or away from the first clamping portion 64 along the guiding slot 444. The scale of the pin 88 aligns with the end surface 443 to show a distance between distal ends of the first and second clamping portions 64 and 86. In use, the distance is equal to a distance between two opposite pins of an electronic component clamped by the first and second clamping portions 64 and 86.

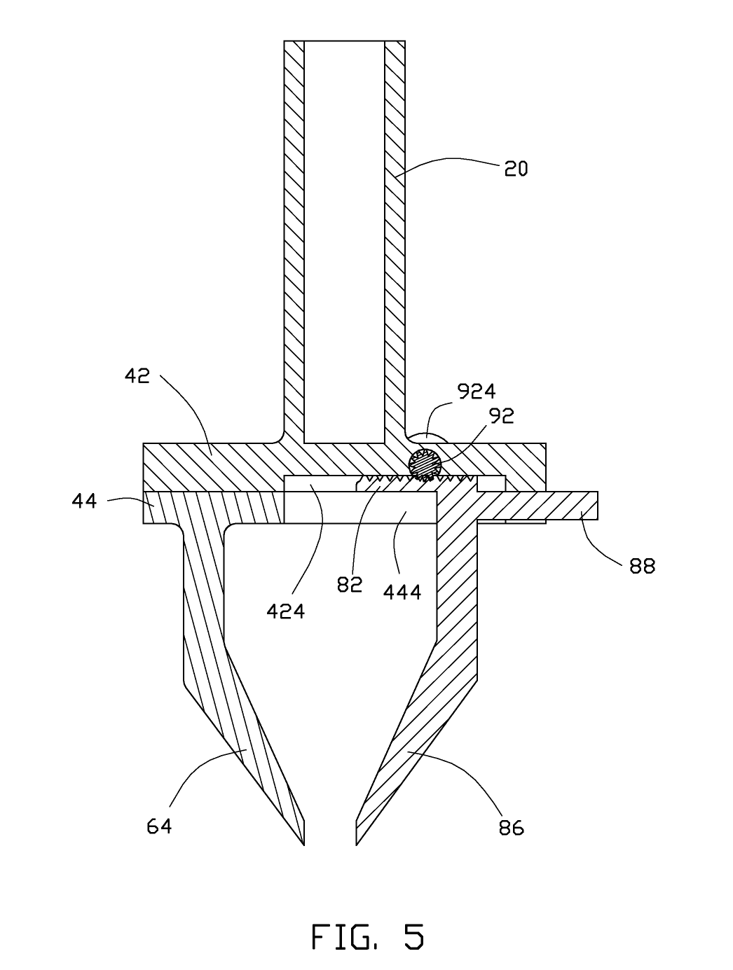

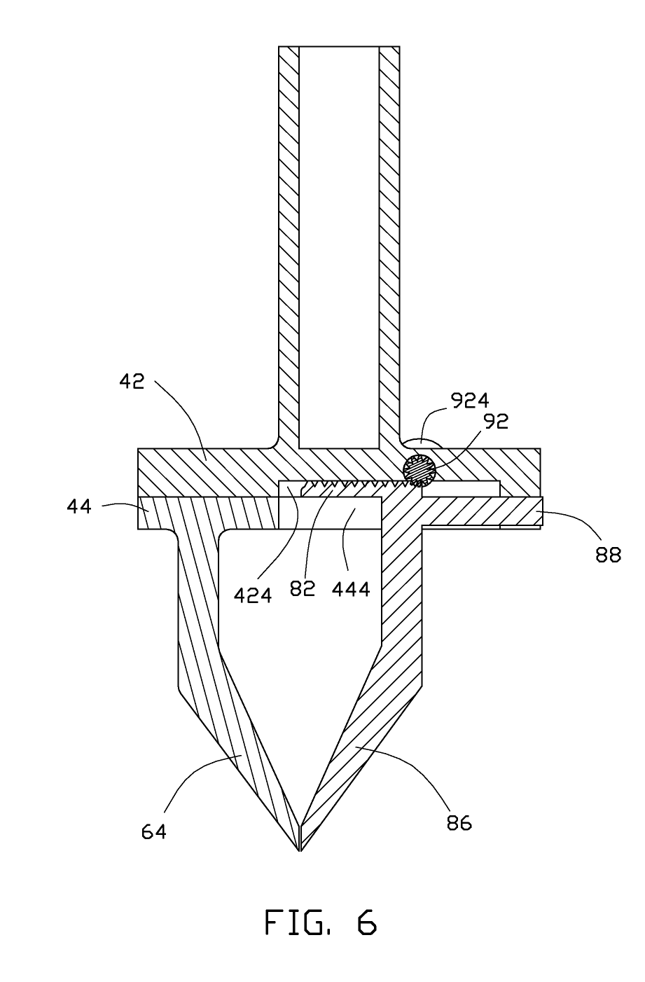

FIG. 5 and FIG. 6, show the operation portion 924 being operated to rotate the gear 92 to drive the gear rack 82. Allowing the second heating block 80 to slide relative to the first clamping portion 60, until the distal ends of the first and second clamping portions 64 and 86 can clamp the pins of the electronic component. The heat-conducting pipe 20 is connected to a heating pole of an ordinary electric soldering iron (not shown). The heating pole generates a quantity of heat, the heat is guided to the first and second clamping portions 64 and 86, to solder the pins of the electronic component to the corresponding pads of a printed circuit board (not show).

Even though numerous characteristics and advantages of the embodiments have been set forth in the foregoing description, together with details of the structure and the functions of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. An electrical soldering iron head comprising:
a heat-conducing pipe;
a connecting member mounted to the heat-conducting pipe;
a first heating block extending down from the connecting member, and comprising a first clamping portion;
a second heating block slidably attached to the connecting member, the second heating block comprising a gear rack and a second clamping portion facing the first clamping portion; and
an operation member rotatably installed to the connecting member, wherein the operation member comprises a gear meshing with the gear rack, the operation member is operable to rotate the gear to drive the gear rack of the second heating block to slide, thereby the second clamping portion moving toward or away from the first clamping portion.

2. The electrical soldering iron head of claim 1, wherein the connecting member comprises a fixing block fixed to the conducing pipe, and an installing block mounted to a bottom of the fixing block, the fixing block defines a receiving space facing the installing block, and a through hole extending through two opposite side surfaces of the fixing block and communicated with the receiving space, the gear is rotatably inserted into the through hole, the gear rack is slidably received in the receiving space to mesh with the gear.

3. The electrical soldering iron head of claim 2, wherein the first heating block comprises an extending pole extending down from the installing block opposite to the fixing block, the first clamping portion slantingly extends down from a distal end of the extending pole toward the second clamping portion.

4. The electrical soldering iron head of claim 2, wherein the installing block defines a guiding slot, the second clamping portion further comprises an extending pole extending down from the gear rack and slidably extending through the guiding slot, the second clamping portion slantingly extends from a distal end of the extending pole toward to the first clamping portion.

5. The electrical soldering iron head of claim 4, wherein an end surface of the installing block defines a cutout communicating with the guiding slot, a pin extends from the extending pole of the second heating block, the pin is slidably extends through the cutout.

6. The electrical soldering iron head of claim 5, wherein a side surface of the pin is marked with a length scale, to show a distance between distal ends of the first and second clamping portions.

7. The electrical soldering iron head of claim 2, wherein the operation member further comprises an operation portion extending out from a first end of the gear, the operation portion is located outside the fixing block.

8. The electrical soldering iron head of claim 7, wherein second end of the gear axially defines a screw hole, a screw extends through the through hole of the fixing block to screw into the screw hole.
